(19) United States
(12) Patent Application Publication
(10) Pub. No.: US 2010/0204397 A1
(43) Pub. Date: Aug. 12, 2010

(54) RUBBER LATEX, RUBBER LATEX FOR DIP MOLDING, AND DIP-MOLDED ARTICLE

(75) Inventors: Osamu Kobayashi, Kanagawa (JP); Reiko Sugimura, Kanagawa (JP)

Correspondence Address: BIRCH STEWART KOLASCH & BIRCH, PO BOX 747, FALLS CHURCH, VA, 22040-0747, US

(73) Assignee: ZEON CORPORATION, TOKYO (JP)

(21) Appl. No.: 12/593,188

(22) PCT Filed: Feb. 28, 2008
(86) PCT No.: PCT/JP2008/053521

§ 371 Date: Oct. 21, 2009

(30) Foreign Application Priority Data
Mar. 27, 2007 (JP) 2007-081336

(51) Int. Cl. C08L 9/08

(52) U.S. Cl. 524/575

(57) ABSTRACT

[Problems] To provide a dip-molded article suitable for use in gloves, particularly gloves for medical use and the like, which has excellent strength and wearing feeling and is not deteriorated even when the article is sterilized by the irradiation with gamma rays, and a rubber latex suitable as a rubber latex for dip molding for obtaining the dip-molded article.

[Means for Resolution] A rubber latex comprising a rubber and an antioxidant, wherein an antioxidant in a first existing form is present in a rubber constituting the rubber latex, and an antioxidant in a second existing form has a melting point of 40° C. or higher and is present in a dispersion medium constituting the rubber latex, and a method for producing the rubber latex are provided. A dip-molded article obtained using the rubber latex is further provided.

### TECHNICAL FIELD

The present invention relates to a rubber latex, a rubber latex for dip molding, and a dip-molded article. More particularly, the invention relates to a dip-molded article suitable for use in gloves, particularly gloves for medical use and the like, which has excellent strength and wearing feeling and is not deteriorated even when the article is sterilized by the irradiation with gamma rays, a rubber latex for dip molding for obtaining the dip-molded article, and a rubber latex.

### BACKGROUND ART

Various devices used in medical services (medical devices) are required to be abacterial. Means such as sterilization by dipping in an antibacterial agent such as formalin, sterilization with ethylene oxide gas, sterilization with ozone, sterilization with radiation and sterilization with high-pressure steam are employed as a method for the sterilization of medical devices. Of these methods, the sterilization with formalin, ozone and ethylene oxide gas may give rise to the problem on toxicity of residues after sterilization, and the sterilization with high-pressure steam may not sufficiently sterilize devices minutely when the device has a complicated structure.

On the other hand, the sterilization with radiation requires neither operation of injection of medicines into an object to be sterilized nor ejection of the medicines from the object sterilized, and therefore can permit the sterilization treatment in a completely sealed system. An apparatus for the sterilization treatment is relatively large-scaled, but the sterilization effect is large and is assured.

However, the irradiation with radiation encounters the problem of discoloration or deterioration of a polymer compound constituting medical devices.

In view of the above, selection of a polymer compound having a saturated structure skeleton as the polymer compound and modification of the structure of the polymer compound are employed. However, the polymer structure is naturally restricted by the intended use of medical devices. For this reason, compounding of an antioxidant is proposed as a method that is applicable regardless of the kind of the polymer compound.

Patent Document 1 discloses a radiation-resistant resin composition comprising polybutadiene and, incorporated therewith, a phosphite bearing an aromatic ring in the molecule. This composition is used for, for example, an infusion set, an infusion bag and the like.

Patent Document 2 discloses a medical molded article comprised of a polyolefin resin composition that comprises a polyolefin resin and, incorporated therewith, a cyclic organic phosphate ester compound. Particularly, the medical molded article is preferably used for an injection cylinder, infusion/transfusion sets and the like.

Patent Document 3 discloses a polypropylene composition comprising polypropylene, other olefin, an organophosphorous thermal stabilizer, and a hindered amine light stabilizer. The polypropylene composition is preferably used for a vial container, a test tube, a syringe and the like.

Patent Document 4 discloses a medical article comprising a polyolefin resin and, incorporated therewith, a specific phosphite compound.

Patent Document 5 discloses a polypropylene resin composition comprising a polypropylene resin, and incorporated therewith, a dialkyl aminoalcohol and a hindered amine compound. This resin composition is suitable for use in a syringe, an ampule, a Petri dish and the like.

Patent Document 6 discloses a resin composition comprising an alicyclic structure-containing polymer and a phenolic antioxidant. This resin composition is suitable for used in a prefilled syringe, a press-through package, an eye-drop container, and the like.

The resin compositions described in these Patent Documents are thought to suffer from neither discoloration nor deterioration even when irradiated with radiation.

Patent Document 1: JP-A-5-192390

Patent Document 2: JP-A-7-236689

Patent Document 3: JP-A-9-296085

Patent Document 4: JP-A-5-339431

Patent Document 5: JP-A-2002-97322

Patent Document 6: JP-A-2005-54123

Many medical devices including medical gloves are produced of a natural rubber, or a synthetic rubber such as a styrene/isoprene/styrene block copolymer, an acrylonitrile/butadiene copolymer rubber or the like. These various rubber products contain an antioxidant, which prevents deterioration of the rubber products caused by heat, light, or the lapse of time.

However, it has been pointed out that irradiation of the medical devices with radiation for sterilization causes the problem of easy deterioration of a rubber constituting medical devices.

In view of the above, one might bear in mind application of the methods described in the above patent publications to the various rubbers. However, the application does not give the expected effects.

This is because, whereas the resins reported in the above patent publications are basically hard and have a saturated structure, a rubber used in medical devices is soft and has an unsaturated structure in many cases.

Medical gloves, in particular, are extremely thin for the reason that a worker wears the gloves and must conduct delicate works. Therefore, the medical gloves are thought to be readily deteriorated particularly by irradiation with radiation.

### DISCLOSURE OF THE INVENTION

### Problems to be Solved by the Invention

Accordingly, one object of the present invention is to provide a rubber dip-molded article for medical use that suffers from neither coloration nor deterioration even when irradiated with radiation for the purpose of sterilization, and a dip-molded article suitable for the article. Another object of the present invention is to provide a latex for dip molding to obtain these molded articles, and a rubber latex suitable therefor. Still another object of the present invention is to provide a method for producing the rubber latex.

### Means for Solving the Problems

As a result of earnest investigations on the constitution of a rubber latex used as a raw material of medical devices to achieve the above objects, the present inventors have found that a rubber latex suffering from no deterioration even when irradiated with gamma rays can be obtained by using a combination of specific two kinds of antioxidants. The present inventors have completed the present invention based on this finding.

Thus, the present invention provides a rubber latex comprising a rubber and an antioxidant, wherein an antioxidant in a first existing form is present in a rubber constituting the rubber latex, and an antioxidant in a second existing form has a melting point of 40° C. or higher and is present in a dispersion medium constituting the rubber latex.

In the rubber latex of the present invention, the antioxidant in a second existing form present in a dispersion medium has preferably a volume-average particle diameter of from 0.01 μm to 10 μm.

In the rubber latex of the present invention, the rubber is preferably a polymer containing a conjugated diene monomer unit as a constituting unit.

In the rubber latex of the present invention, the polymer containing a conjugated diene monomer unit as a constituting unit is preferably a block copolymer of an aromatic vinyl monomer and a conjugated diene monomer, and the block copolymer of an aromatic vinyl monomer and a conjugated diene monomer is preferably a styrene/isoprene/styrene block copolymer.

In the rubber latex of the present invention, the polymer containing a conjugated diene monomer unit as a constituting unit is preferably a polyisoprene.

In the rubber latex of the present invention, the antioxidant in a first existing form is preferably present in an amount of from 0.1 to 3 parts by weight per 100 parts by weight of the rubber.

In the rubber latex of the present invention, the antioxidant in a second existing form is preferably present in an amount of from 0.1 to 3 parts by weight per 100 parts by weight of the rubber.

The present invention further provides a method for producing a rubber latex, comprising mixing an organic solvent solution of a rubber constituting the rubber latex and an antioxidant for constituting an antioxidant in a first existing form, with a surfactant aqueous solution, thereby forming an emulsified product, removing an organic solvent from the emulsified product, and adding an aqueous dispersion of an antioxidant constituting an antioxidant in a second existing form to the emulsified product.

The present invention further provides a rubber latex for dip molding comprising the rubber latex of the present invention.

The present invention further provides a dip-molded article obtained by dip-molding the rubber latex for dip molding.

The present invention further provides a dip-molded article obtained by irradiating the dip-molded article with radiation. The dip-molded article is suitable for medical use.

### Advantages of the Invention

The dip-molded article obtained using the rubber latex of the present invention has excellent mechanical properties such as strength and the like, and suffers from neither coloration nor deterioration even when irradiated with radiation. Therefore, the dip-molded article is most suitable for use in abacterial medical devices requiring sterilization with gamma rays, particularly thin medical devices such as medical gloves and the like.

### BEST MODE FOR CARRYING OUT THE INVENTION

The rubber latex of the present invention comprises a rubber and antioxidants having two kinds of existing forms.

The rubber constituting the rubber latex used in the present invention is not particularly limited, and may be any one of a natural rubber and synthetic rubbers. The rubber is preferably a rubber that can be used for dip-molding.

Specific examples of the rubber include a natural rubber, a conjugated diene rubber, a butyl rubber and a urethane rubber.

The conjugated diene rubber is a homopolymer or a copolymer of conjugated diene monomers, or a copolymer of a conjugated diene monomer with a monomer copolymerizable therewith.

The conjugated diene monomer is not particularly limited. Specific examples of the conjugated diene monomer include 1,3-butadiene, isoprene, 2,3-dimethyl-1,3-butadiene, 2-ethyl-1,3-butadiene, 1,3-pentadiene, chloroprene and the like. These conjugated diene monomers may be used alone, and can be used as a mixture of two or more thereof. Of these monomers, 1,3-butadiene and isoprene are particularly preferably used.

The monomer copolymerizable with the conjugated diene monomer is not particularly limited, and examples thereof include an aromatic vinyl monomer, an ethylenically unsaturated nitrile monomer, an ethylenically unsaturated acid monomer, an ethylenically unsaturated acid derivative monomer, a vinyl heterocyclic compound monomer, a carboxylic acid vinyl ester monomer, a vinyl halide monomer, a vinyl ether monomer, an olefin monomer, and the like.

Of these monomers, an aromatic vinyl monomer, an ethylenically unsaturated nitrile monomer, an ethylenically unsaturated acid monomer and an ethylenically unsaturated acid derivative monomer are preferably used.

Specific examples of the aromatic vinyl monomer include styrene, α-methylstyrene, monochlorostyrene, dichlorostyrene, monomethylstyrene, dimethylstyrene, trimethylstyrene, hydroxymethylstyrene, and the like.

Specific examples of the ethylenically unsaturated nitrile monomer include acrylonitrile, methacrylonitrile, fumaronitrile, α-chloroacrylonitrile, α-cyanoethylacrylonitrile, and the like.

Specific examples of the ethylenically unsaturated acid monomer include monobasic unsaturated acids such as acrylic acid, methacrylic acid, crotonic acid, and the like; and polybasic unsaturated acids such as fumaric acid, maleic acid, itaconic acid, butenetricarboxylic acid, and the like.

Specific examples of the ethylenically unsaturated acid derivative monomer include esters, acid anhydrides and acid amides of an ethylenically unsaturated acid.

Specific examples of the ethylenically unsaturated acid ester monomer include methyl (meth)acrylate, ethyl (meth)acrylate, propyl (meth)acrylate, butyl (meth)acrylate, 2-ethylhexyl (meth)acrylate, decyl (meth) acrylate, dodecyl (meth) acrylate, 2-hydroxyethyl (meth) acrylate, dimethylaminoethyl (meth) acrylate, butyl maleate, butyl fumarate, diethyl maleate, dibutyl fumarate, and the like.

Specific examples of the ethylenically unsaturated acid anhydride monomer include maleic anhydride, itaconic anhydride, and the like.

Specific examples of the amide derivative of an ethylenically unsaturated monocarboxylic acid include (meth) acrylamide, N-methylol (meth) acrylamide, N,N-dimethyl (meth) acrylamide, (meth) acrylamide-2-methylpropanesulfonic acid and its sodium salt, and the like.

In the present invention, the term “(meth)acryl” means “acryl” and/or “methacryl”.

Specific examples of the vinyl heterocyclic compound monomer include vinylpyridine, N-vinylpyrrolidone, and the like.

Specific examples of the carboxylic acid vinyl ester monomer include vinyl formate, vinyl acetate, vinyl propionate, vinyl pivalate, isopropenyl acetate, vinyl versatate, and the like.

Specific examples of the vinyl halide monomer include vinyl chloride, vinylidene chloride, vinyl fluoride, vinylidene fluoride, and the like.

Specific examples of the vinyl ether monomer include methyl vinyl ether, n-propyl vinyl ether, isopropyl vinyl ether, n-butyl vinyl ether, isobutyl vinyl ether, t-butyl vinyl ether, dodecyl vinyl ether, and the like.

Specific examples of the olefin monomer include ethylene, propylene, 1-butene, isobutene, and the like.

Preferred specific examples of the conjugated diene rubber include a natural rubber, a polybutadiene rubber, a polyisoprene rubber, a styrene/butadiene copolymer rubber, a carboxyl-modified styrene/butadiene copolymer rubber, a styrene/isoprene copolymer rubber, a carboxyl-modified styrene/isoprene copolymer rubber, an acrylonitrile/butadiene copolymer rubber, a carboxyl-modified acrylonitrile/butadiene copolymer rubber, an acrylonitrile/isoprene copolymer rubber, a carboxyl-modified acrylonitrile/isoprene copolymer rubber, an acrylonitrile/butadiene/isoprene copolymer rubber, a carboxyl-modified acrylonitrile/butadiene/isoprene copolymer rubber, a styrene/butadiene/styrene block copolymer, a styrene/isoprene/styrene block copolymer, and their hydrogenated products.

Of these, polymers containing a conjugated diene monomer unit as a constituting unit are preferred, and a block copolymer of an aromatic vinyl monomer with a conjugated diene monomer, and polyisoprene are particularly preferred.

Specific examples of the block copolymer of an aromatic vinyl monomer with a conjugated diene monomer include a styrene/butadiene/styrene block copolymer, a styrene/isoprene/styrene block copolymer, a styrene/ethylene/butylene/styrene block copolymer, styrene/ethylene/propylene/styrene block copolymer, and the like. Of these, a styrene/isoprene/styrene block copolymer is preferred.

Molded articles obtained from polyisoprene and the block copolymers have excellent strength, durability, wearing feeling and barrier properties, and have a less content of impurities. Therefore, the molded articles are suitably used in dip-molded articles for medical use, including gloves.

Weight-average molecular weight of the rubber used in the present invention is not particularly limited. When the rubber latex of the present invention is used for dip molding, the rubber has preferably a weight-average molecular weight within a range of from 50,000 to 5,000,000.

In the present invention, glass transition temperature of the rubber is not particularly limited.

In the present invention, the gel content (toluene- or tetrahydrofuran-insoluble matter) of the rubber is not particularly limited. When the rubber latex of the present invention is used for dip molding, the rubber has preferably the gel content within a range of from 0 to 80% by weight.

In the styrene/isoprene/styrene block copolymer suitably used in the present invention, the styrene block has preferably a weight-average molecular weight of from 8,000 to 50,000, and the isoprene block has preferably a weight-average molecular weight of from 50,000 to 500,000.

The polyisoprene suitably used in the present invention has preferably a weight-average molecular weight of from 500,000 to 3,000,000.

In the rubber latex of the present invention, the concentration of the rubber is not particularly limited. The rubber concentration is preferably from 20 to 74% by weight, more preferably from 30 to 70% by weight, and particularly preferably from 40 to 70% by weight.

Where the rubber concentration is too low, the viscosity of the rubber latex is too low, and as a result, the rubber component may separate during storage. On the other hand, where the rubber concentration is too high, the rubber component may flocculate.

A method for producing a rubber constituting the rubber latex of the present invention is not particularly limited. The rubber may be produced by any one of an emulsion polymerization method, a suspension polymerization method, a solution polymerization method, and the like. Considering the preferred preparation method of the rubber latex of the present invention, the rubber is preferably produced by a solution polymerization method. The rubber produced by a solution polymerization method may directly be used in the preparation of the rubber latex. Alternatively, the rubber may be once coagulated, passed through a step such as purification, and then used in the preparation of the rubber latex.

The rubber produced by an emulsion polymerization method or a suspension polymerization method can be once formed into a solid rubber, and then dissolved in a solvent.

A method for producing the rubber used in the present invention is not particularly limited, and conventional methods can be used.

The antioxidant is present in two kinds of forms in the rubber latex of the present invention.

The antioxidant in a first existing form is present in a state that the antioxidant is compatibilized with the rubber constituting the rubber latex. The term “present in a compatibilized state” used herein includes an embodiment that the antioxidant is uniformly mixed with a rubber, and further includes an embodiment that the antioxidant is present as an island in a rubber as a sea.

The antioxidant for constituting an antioxidant in a first existing form (hereinafter sometimes simply referred to as a “first antioxidant”) is not particularly limited, and can be any antioxidant so long as the antioxidant is compatibilized with the rubber constituting the rubber latex.

Specific examples of the first antioxidant include phenolic antioxidants such as 2,6-di-t-butyl-4-methylphenol (melting point: 69° C.), 2,6,-di-t-butylphenol (melting point: 36° C.), 2,6-di-t-butyl-4-methylphenol (melting point 44-45° C.), butyl hydroxyanisole (melting point: 57-65° C.), 2,6-di-t-butyl-α-dimethylamino-p-cresol (melting point: 94° C.), octadecyl-3-(3,5-di-t-butyl-4-hydroxyphenyl)propionate (melting point 50-55° C.), styrenated phenol (liquid), 2,2′-methylenebis(6-α-methylbenzyl-p-cresol) (melting point: about 115° C.), 4,4′-methylenebis (2,6-di-t-butylphenol) (melting point: 154° C. or higher), 2,2′-methylenebis(4-methyl-6-t-butylphenol) (melting point: 120° C. or higher), alkylated bisphenol (liquid), a butylation reaction product (melting point: 110° C.) of p-cresol and dicyclopentadiene, and the like; thiobisphenolic antioxidants such as 2,2′-thiobis(4-methyl-6-t-butylphenol) (melting point: 81-86° C. or higher), 4,4′-thiobis(6-t-butyl-o-cresol) (melting point: 127° C.), 2,6-di-t-butyl-4-(4,6-bis(octylthio)-1,3,5-triazin-2-ylamino)phenol (melting point: 91-96° C.), and the like; phosphite ester antioxidants such as tris(nonylphenyl)phosphite (liquid), diphenylisodecyl phosphite (liquid), tetraphenyl dipropylene glycol-diphosphite (liquid), and the like; sulfur ester antioxidants such as dilauryl thiodipropionate (melting point: 37° C. or higher) and the like; amine antioxidants such as phenyl-α-naphthylamine (melting point: 50° C. or higher), phenyl-p-naphthylamine (melting point: 90° C. or higher), p-(p-toluenesulfonylamide)diphenylamine (melting point: 135° C. or higher), 4,4′-(α,α′-dimethylbenzyl)-diphenylamine (melting point: 37° C. or higher), N,N-diphenyl-p-phenylenediamine (melting point: 130° C. or higher), N-isopropyl-N′-phenyl-p-phenylenediamine (melting point: 70° C. or higher), and butyl aldehyde/aniline condensate (liquid), and the like; quinoline antioxidants such as 6-ethoxy-2,2,4-trimethyl-1,2-dihydroquinoline (liquid), and the like; and hydroquinone antioxidants such as 2,5-di-(t-amyl)hydroquinone (melting point: 170° C. or higher), and the like; and the like. The term “liquid” used herein means that the compound is liquid at 40° C.

These antioxidants may be used alone or as a mixture of two or more thereof.

Of the above compounds, 6-di-t-butyl-4-(4,6-bis(octylthio)-1,3-5-triazin-2-ylamino)phenol and octadecyl-3-(3,5-di-t-butyl-4-hydroxyphenyl)propionate are preferred as the first antioxidant.

The amount of the first antioxidant used is preferably within a range of from 0.1 to 3 parts by weight, more preferably within a range of from 0.15 to 2 parts by weight, and particularly preferably within a range of from 0.3 to 1.5 parts by weight, per 100 parts by weight of the rubber constituting the rubber latex.

Where the amount of the first antioxidant used is too small, the first antioxidant is easily consumed when the dip-molded article obtained from the rubber latex is irradiated with radiation or ultraviolet rays, and this gives rise to the problem of lowering in strength of the dip-molded article. On the other hand, too large an amount is economically disadvantageous, and additionally could induce the problems that strength of the dip-molded article is lowered, and the first antioxidant is eluted from the dip-molded article, contaminating the environment.

The presence of the first antioxidant in the rubber can be confirmed by separating an antioxidant in a second existing form from the rubber latex with centrifugal separation or membrane separation and then analyzing the rubber constituting the rubber latex.

The volume-average particle diameter of the rubber particle constituting the rubber latex is not particularly limited. The volume-average particle diameter is generally from 0.05 to 3 μm, and preferably from 0.2 to 2 μm. Where the volume-average particle diameter of the rubber particle is smaller than 0.05 μm, particles become unstable, and furthermore, viscosity of the rubber latex is increased. As a result, the solid content concentration of the latex cannot be increased. On the other hand, where the volume-average particle diameter of the rubber particle is larger than 3 μm, the rubber particles are liable to float. As a result, a film is liable to be formed on the surface of the latex when the latex is allowed to stand.

In the rubber latex of the present invention, the antioxidant in a second existing form is present in a dispersion medium constituting the rubber latex. In other words, the antioxidant in a second existing form is dispersed in the dispersion medium constituting the latex.

An antioxidant for constituting the antioxidant in a second existing form (hereinafter sometimes referred to as a “second antioxidant”) is required to have a melting point of 40° C. or higher.

When an antioxidant having a melting point lower than 40° C. is used, the antioxidant is easily consumed when the dip-molded article obtained from the latex containing the antioxidant is irradiated with radiation or ultraviolet rays. As a result, strength of the dip-molded article is decreased by the subsequent heat treatment.

The second antioxidant has a melting point of preferably 120° C. or lower. When the antioxidant having a melting point higher than 120° C. is used, it is preferable to use a small amount of a solvent or a plasticizer together.

The second antioxidant may be used alone or as a mixture of two or more thereof. The second antioxidant may be the same compound as the first antioxidant.

Specific examples of the second antioxidant include phenol compounds such as 2,6-di-t-butyl-4-methylphenol (melting point: 69° C.), 2,6-di-t-butyl-4-methylphenol (melting point: 44-45° C.), butyl hydroxyanisole (melting point: 57-65° C.), 2,6-di-t-butyl-α-dimethylamino-p-cresol (melting point: 94° C.), octadecyl-3-(3,5-di-t-butyl-4-hydroxyphenyl)propionate (melting point: 50-55° C.), 2,2′-mehtylenebis(6-α-methylbenzyl-p-cresol) (melting point: about 115° C.), 4,4′-methylenebis(2,6-di-t-butylphenol) (melting point: 154° C. or higher), 2,2′-methylenebis(4-methyl-6-t-butylphenol) (melting point: 120° C. or higher), butylation reaction product (melting point: 110° C.) of p-cresol and dicylcopentadiene, and the like; thiobisphenol compounds such as 2,2′-thiobis(4-methyl-6-t-butylphenol) (melting point: 81-86° C. or higher), 4,4′-thiobis(6-t-butyl-o-cresol) (melting point: 127° C.), 2,6-di-t-butyl-4-(4,6-bis(octylthio)-1,3,5-triazin-2-ylamino)phenol (melting point: 91-96° C.), and the like; and the like.

Of the above compounds, an aqueous dispersion of octadecyl-3-(3,5-di-t-butyl-4-hydroxyphenyl)propionate (melting point: 50-55° C.) and an aqueous dispersion of a butylation reaction product (melting point: 110° C.) of p-cresol and dicyclopentadiene are preferred as the second antioxidant.

In the rubber latex of the present invention, the second antioxidant has a volume-average particle diameter of preferably from 0.01 to 10 μm, and more preferably from 0.05 to 5 μm, in the dispersion medium.

Where the volume-average particle diameter is excessively smaller than 0.01 μm, the second antioxidant having such a volume-average particle diameter is easily consumed when the dip-molded article obtained from the rubber latex is irradiated with radiation or ultraviolet rays, and strength of the dip-molded article may be decreased. On the other hand, where the volume-average particle diameter is excessively larger than 10 μm, strength of the dip-molded article obtained from the rubber latex may be decreased by a heat treatment after the dip-molded article is irradiated with radiation or ultraviolet rays.

The volume-average particle diameter of the antioxidant is obtained as an average particle diameter calculated as an arithmetic average based on a particle size distribution based on the volume of particles using a light-scattering diffraction particle size analyzer (for example, trade name: LS-230, a product of Coulter).

The amount of the second antioxidant used is preferably within a range of from 0.1 to 3 parts by weight, more preferably within a range of from 0.2 to 2 parts by weight, and particularly preferably within a range of from 0.5 to 1.5 parts by weight, per 100 parts by weight of the rubber constituting the rubber latex.

Where the amount of the second antioxidant used is too small, strength of the dip-molded article obtained using the rubber latex may be decreased by the heat treatment after the irradiation with radiation or ultraviolet rays. On the other hand, too large an amount is economically disadvantageous, and may lower strength of the dip-molded article.

The presence of the second antioxidant in the dispersion medium constituting the rubber latex can be confirmed by centrifugal separation of the latex and subsequent analysis of a lower layer (precipitate) (in the case that a specific gravity of the antioxidant is larger than that of water).

The rubber latex of the present invention comprises the rubber constituting the rubber latex, and the first and the second antioxidants, and further comprises a surfactant for dispersing the rubber in a dispersion medium, and/or a dispersing agent for dispersing the second antioxidant in the dispersion medium as the constituting elements.

The surfactant for causing the rubber constituting the rubber latex as rubber particles to be present in the dispersion medium is not particularly limited, but an anionic surfactant is preferred.

Specific examples of the anionic surfactant include a carboxylic acid salt surfactant, a sulfonic acid salt surfactant, a sulfate ester surfactant and a phosphate ester surfactant.

Specific examples of the carboxylic acid salt surfactant include a fatty acid salt, an N-acylamino acid and its salt, a polyoxyethylene alkyl ether carboxylic acid salt, an acylated peptide, and the like.

Specific examples of the sulfonic acid salt surfactant include an alkyl benzene sulfonic acid salt, an alkyl naphthalene sulfonic acid salt, a naphthalene sulfonic acid salt/formalin condensate, a melamine sulfonic acid salt/formalin condensate, a dialkyl sulfosuccinic acid salt, an alkyl sulfoacetic acid salt, an α-olefin sulfonic acid salt, an N-acyl alkyl sulfonic acid salt, and the like.

Specific examples of the sulfate ester salt surfactant include sulfated oil, a higher alcohol sulfate ester salt, a polyoxyethylene alkyl ether sulfate salt, a higher alcohol ethoxysulfate salt, a polyoxyethylene alkyl phenyl ether sulfate salt, a monofatty acid glyceryl sulfate salt, a fatty acid alkylol amide sulfate ester salt, and the like.

Specific examples of the phosphate ester salt surfactant include an alkyl ether phosphate ester salt, an alkyl phosphate ester salt, and the like.

Of these anionic surfactants, a fatty acid salt and an alkyl benzene sulfonic acid salt are preferred.

A nonionic surfactant, or an anionic or nonionic polymer dispersion stabilizer can further be used in addition to the anionic surfactant.

Examples of the nonionic surfactant include a polyoxyethylene alkyl ether, a polyoxyethylene alkyl phenyl ether, a polyoxyethylene sorbitan alkylate, an oxyethylene/oxypropylene block copolymer, polyglycerin ester, and the like.

Examples of the polymer dispersion stabilizer include polyvinyl alcohol, hydroxyethyl cellulose, methyl cellulose, hydroxypropyl cellulose, a polyacrylic acid salt, a polyacrylate ester salt, sodium alginate, and the like.

The amount of the surfactant used is generally from 1 to 30 parts by weight, and preferably from 1 to 20 parts by weight, per 100 parts by weight of the rubber constituting the rubber latex. Where the amount of the surfactant is too small, stability of the latex may be deteriorated. On the other hand, too large an amount is economically disadvantageous, and gives rise to the problem of vigorous foaming.

If required and necessary, various compounding ingredients can be added to the rubber latex of the present invention.

Specific examples of the compounding ingredients include crosslinking agents, crosslinking accelerators, crosslinking aids, crosslinking retarders, fillers, thickeners, pH-adjusting agents, and antioxidants other than the first and second antioxidants.

The kind and the addition amount of these compounding ingredients can appropriately be selected according to the rubber constituting the rubber latex in view of the intended use of the rubber latex.

A method for producing the rubber latex of the present invention is not particularly limited. The rubber latex can preferably be produced by mixing an organic solvent solution, of a rubber constituting a rubber latex and an antioxidant for constituting an antioxidant in a first existing form, with a surfactant aqueous solution to form an emulsified product, removing the organic solvent from the emulsified product, and then adding an aqueous dispersion of an antioxidant for constituting an antioxidant in a second existing form.

The organic solvent, for preparing the organic solvent solution of a rubber constituting a rubber latex and an antioxidant for constituting an antioxidant in a first existing form, is not particularly limited so long as it can dissolve the rubber constituting the rubber latex.

Specific examples of the organic solvent include aromatic hydrocarbon solvents such as benzene, toluene, xylene, and the like; alicyclic hydrocarbon solvents such as cyclopentane, cyclopentene, cyclohexane, and the like; aliphatic hydrocarbon solvents such as pentane, hexane, heptane, and the like; halogenated hydrocarbon solvents such as methylene chloride, chloroform, ethylene dichloride, and the like; and the like. Of these solvents, aromatic hydrocarbon solvents and alicyclic hydrocarbon solvents are preferred, and aliphatic hydrocarbon solvents are particularly preferred.

The amount of the organic solvent used is generally 2,000 parts by weight or less, preferably from 20 to 1,500 parts by weight, and more preferably from 50 to 1,000 parts by weight, per 100 parts by weight of the rubber.

A method for preparing the organic solvent solution of the rubber constituting the rubber latex and the first antioxidant is not particularly limited. The rubber containing the first antioxidant or a mixture of the rubber and the first antioxidant may be dissolved in an organic solvent, the first antioxidant may be added to an organic solvent solution of the rubber, or the rubber may be dissolved in an organic solvent solution of the first antioxidant. Furthermore, the organic solvent solution may be prepared by methods other than the above methods.

In the present invention, a surfactant used to emulsify the organic solvent solution of a rubber constituting a rubber latex and an antioxidant for constituting an antioxidant in a first existing form is not particularly limited. The anionic surfactant described above can preferably be used as the surfactant.

The amount of the surfactant used is generally from 1 to 30 parts by weight, and preferably 1 to 20 parts by weight, per 100 parts by weight of the rubber constituting the rubber latex. Where the amount of surfactant used is too small, the latex obtained has poor stability. On the other hand, too large an amount of the surfactant is economically disadvantageous, and gives rise to the problem of vigorous foaming.

An apparatus for mixing the organic solvent solution, of the rubber constituting the rubber latex and the first antioxidant, with the surfactant aqueous solution to form an emulsified product is not particularly limited so long as it is generally commercially available as an emulsifying machine or a dispersing machine.

Specific examples of the apparatus include batchwise emulsifiers such as a homogenizer (manufactured by IKA), POLYTRON (manufactured by Kinematica AG), TK autohomomixer (manufactured by Tokushukika Kogyo Co., Ltd.), and the like; continuous emulsifiers such as TK pipe line homomixer (manufactured by Tokushukika Kogyo Co., Ltd.), colloid mill (manufactured by Shinko Pantec Co., Ltd.), a slasher, trigonal wet pulverizer (manufactured by Mitui Miike Machinery Co., Ltd.), CAVITRON (manufactured by Eurotec, Ltd.), a milder, Fine Flow Mill (manufactured by Pacific Machinery & Engineering Co., Ltd.), and the like; high-pressure emulsifiers such as Microfluidizer (manufactured by Mizuho Kogyo K.K.), Nanomizer (manufactured by Nanomizer Inc.), APV Gaulin (manufactured by Gaulin), and the like; film emulsifiers such as a film emulsifier (manufactured by Reica Co., Ltd.), and the like; vibration emulsifiers such as Vibromixer (manufactured by Reica Co., Ltd.), and the like; ultrasonic emulsifiers such as Ultrasonic Homogenizer (manufactured by Branson), and the like; and the like.

The organic solvent is removed from the emulsified product obtained by mixing the organic solvent solution of the rubber constituting the rubber latex and the antioxidant for constituting the antioxidant in a first existing form with the surfactant aqueous solution.

A method for removing the organic solvent from the emulsified product is not particularly limited. Methods such as reduced-pressure distillation, ordinary pressure distillation and steam distillation can be used.

An aqueous dispersion of the second antioxidant is added to and mixed with the rubber latex comprising the rubber and the first antioxidant. The mixing method is not particularly limited.

The aqueous dispersion of the second antioxidant comprises the second antioxidant dispersed in water by a dispersing agent. The aqueous dispersion in this case is a concept to include an emulsified liquid.

In the aqueous dispersion of the second antioxidant, the concentration of the antioxidant is not particularly limited. The concentration of the antioxidant is generally from 10 to 65% by weight, preferably from 20 to 60% by weight, and further preferably from 30 to 55% by weight.

Examples of the dispersing agent for preparing the aqueous dispersion of the antioxidant include nonionic emulsifying agents such as a polyoxyethylene alkyl ether, a polyoxyethylene alkyl phenol ether, a polyoxyethylene alkyl ester, a polyoxyethylene sorbitan alkyl ester, and the like; anionic emulsifying agents such as a fatty acid (such as myristic acid, palmitic acid, oleic acid and linolenic acid) and its salt, a higher alcohol sulfate ester, an alkyl sulfosuccinic acid, an alkyl benzene sulfonate, an alkyl diphenyl ether sulfonate, an aliphatic sulfonate, and the like; cationic emulsifying agents such as an ammonium chloride (such as trimethyl ammonium chloride and dialkyl ammonium chloride), a benzyl ammonium salt, a quaternary ammonium salt, and the like; copolymerizable emulsifying agents such as a sulfoester of α,β-unsaturated carboxylic acid, a sulfate ester of α,β-unsaturated carboxylic acid, a sulfoalkyl aryl ether, and the like; polymer dispersing agents such as polyvinyl alcohol, polyvinyl pyrrolidone, sodium polystyrene sulfonate, sodium polyacrylate, formaldehyde condensate of sodium naphthalene sulfonate, and the like; and the like. Furthermore, the dispersing agent can appropriately be selected from the above-described surfactants.

Of these, anionic emulsifying agents or polymer dispersing agents are preferably used. These dispersing agents can be used alone or as a mixture of two or more thereof. The amount of the dispersing agent used is not particularly limited, but is preferably from 5 to 20% by weight based on the weight of the antioxidant.

A method for preparing the aqueous dispersion of the second antioxidant is not particularly limited. The aqueous dispersion is generally prepared by an emulsion method or a pulverization method. The emulsion method is a method comprising stirring an antioxidant made into a liquid form, if necessary, by heating, an emulsifying agent and hot water at a sufficiently high speed to prepare an emulsion thereof. As the dispersing medium of the antioxidant dispersion is water, the melting point of the antioxidant that can be used in the emulsion method is 100° C. (boiling point of water) or lower, and preferably 90° C. or lower.

The pulverization method is a method comprising mechanically fine-graining a solid product having a high boiling point that cannot be used in the emulsion method to prepare a dispersion thereof. The pulverization method includes a dry pulverization method where a turbo mill, a jet mill or the like is used and a wet pulverization method where a colloid mill and the like is used. The wet pulverization method is preferred for the reason that a particle diameter achieved by pulverization is small and heat evolution during pulverization is small. Of the wet pulverization method, a media type wet pulverization method is preferred. The media type wet pulverization method can use a ball mill, a high-speed bead mill, and the like. Of these, pulverization by a high-speed bead mill is preferred.

The high-speed bead mill method is described further specifically below. Spherical media are charged in a cylindrical container, and rotated at a high speed using an agitator shaft. An antioxidant is fed using a pump to the container having the media moving therein, and the antioxidant is pulverized batchwise or continuously. The media used are small beads having a diameter of 0.5 mm or more, preferably from 0.5 to 10 mm, and further preferably 0.5 to 3 mm. The beads generally have a density of 2 g/cm³ or more. High hardness ceramics such as zirconia, and high hardness metals such as steel are preferably used as a material of beads. The amount of the beads charged is preferably from 60 to 95%, and further preferably from 70 to 85%, in consideration of pulverization efficiency.

The rubber latex of the present invention holds sufficient strength even after the dip-molded article obtained from the rubber latex is subjected to a sterilization treatment by irradiation with radiation. Therefore, the rubber latex is preferred as one for dip molding, and various dip-molded articles can be obtained from the rubber latex.

The rubber latex for dip molding of the present invention comprises the rubber latex. The rubber latex for dip molding may contain additives, conventionally known in the dip molding, such as crosslinking agents, crosslinking aids, coloring materials, preservatives, antibacterial agents, dispersion stabilizers and the like, in addition to the rubber latex.

A method for dip-molding the rubber latex for dip molding of the present invention is not particularly limited and conventional methods can be used.

For example, the dip-molded article can be obtained by forming a layer of a dip-molded article comprising the rubber latex for dip molding of the present invention on a mold for dip molding.

In dip-molding, a layer of a first rubber latex for dip molding may be formed on a mold for dip molding, and a layer of a second rubber latex for dip molding may further be formed on the layer of the first rubber latex. In this case, the first rubber latex for dip molding and the second rubber latex for dip molding may be the same or different. Either one of the first and second rubber latexes may be a rubber latex for dip molding other than the rubber latex for molding of the present invention. The rubber latex for dip molding may form three layers or more.

A mold for dip molding may be a mold made of any one of porcelain, pottery, metal, glass, plastic, and the like.

Where the dip-molded article is a glove, the mold has a shape corresponding to the contour of hands. Molds having various shapes, such as a mold having a shape of from a wrist to fingertips, and a mold having a shape of from an elbow to fingertips, can be used according to the purpose of use of gloves to be produced.

The dip-molded article of the present invention is obtained by dip-molding the rubber latex for dip molding of the present invention.

The thickness of the dip-molded article of the present invention is not particularly limited, and is preferably from 0.01 to 3 mm, and more preferably from 0.02 to 1 mm, in terms of a thickness of a layer of a composition for molding.

Specific examples of the dip-molded article obtained from the rubber latex of the present invention include medical supplies such as nipples for baby bottles, droppers and water pillows; toys and sporting goods, such as balloons, dolls and balls; industrial goods such as bags for pressure molding and bags for gas storage; surgical, diagnostic, domestic, agricultural, fishery and industrial unsupported gloves; supported gloves; fingerstalls; catheter balloons; thermal-peeling balloons for uterus; catheter cuffs; condoms; Dutch caps; indwelling urine output catheters; and men's external urine output catheters.

The dip-molded article obtained from the rubber latex of the present invention is irradiated with radiation to give a sterilized dip-molded article.

Examples of the radiation include gamma rays, X-rays and electron beams and Gamma rays from cobalt 60 is preferred. The absorption dose is generally from 10 to 70 kGy, and preferably from 20 to 55 kGy.

The dip-molded article of the present invention has excellent radiation resistance. Therefore, the dip-molded article is preferably used in various products for medical use requiring sterilization with radiation.

Specific examples of the product include medical supplies such as surgical gloves, nipples for baby bottles, droppers, conduit tubes, water pillows, and the like.

### EXAMPLES

The present invention is described further specifically by reference to the following Examples, but the invention is not construed as being limited thereto. Unless otherwise indicated, “%” and “parts” in the Examples are by weight.

### (Volume-Average Particle Diameter Of Antioxidant)

The volume-average particle diameter is obtained as an average particle diameter calculated in terms of arithmetic average on the basis of volume standard of particles using a light-scattering diffraction particle size analyzer (trade name: LS-230, manufactured by Coulter).

### (Confirmation of the Presence of an Antioxidant in the Rubber and the Dispersion Medium)

A latex is diluted to a solid content concentration of 10% using ion-exchanged water. The diluted latex is centrifuged with a centrifuge under the condition of 40,000 G for 5 minutes to separate the diluted latex into three layers of an upper layer (rubber), a middle layer (aqueous layer) and a lower layer (precipitate). The upper layer is extracted with acetone, and an antioxidant is qualitatively analyzed with liquid chromatography, thereby confirming that the antioxidant is present in the rubber.

On the other hand, the antioxidant present in the lower layer (precipitate) is qualitatively analyzed with liquid chromatography, thereby confirming that the antioxidant is present in the dispersion medium.

Conditions of gamma ray-irradiation and the heat treatment of a film and the measurement method of the tensile strength of the film are as follows.

### (Gamma Ray-Irradiation of Film)

A film after annealed is irradiated with gamma rays in a dose of 25 kGy.

### (Heat Treatment)

A film irradiated with gamma rays is hung on a rotator with a clip in a gear oven at 70° C. The film is held for 166 hours while rotating the film.

### (Tensile Strength Test)

The tensile strength is measured according to the ASTM D412 standard test method.

### Example 1

100 parts of a styrene/isoprene/styrene block copolymer: SIS (styrene content: 14%, molecular weight: 230,000, manufactured by Zeon Corporation, trade name: QUINTAC 3620), 233.3 parts of cyclohexane and 0.5 part of a first antioxidant 1A: 2,6-di-t-butyl-4-(4,6-bis(octylthio)-1,3,5-triazin-2-ylamino)phenol (manufactured by Ciba Specialty Chemicals, trade name: IRGANOX 565) were added to a separable flask, and these were dissolved at room temperature under stirring.

A solution obtained by dissolving 8.3 parts of sodium dodecylbenzenesulfonate in 325 parts of water was added to the cyclohexane solution obtained, and the stirring was continued. The resulting solution was circulated 10 times using a rotor-stator emulsifier (manufactured by Pacific Machinery & Engineering Co., Ltd., trade name: MILDER 303V). Thus, an emulsified liquid was obtained.

Cyclohexane and water were distilled away from the emulsified liquid obtained at 80° C. under reduced pressure of from −0.01 to −0.09 MPa to concentrate the liquid to a solid content concentration of 45%. Volume-average particle diameter of SIS in the emulsified liquid was 1.5 μm.

2.22 parts of an aqueous dispersion (antioxidant concentration: 45%) comprising 1 part of a second antioxidant 2A: octadecyl-3-(3,5-di-t-butyl-4-hydroxyphenyl)propionate (melting point: 50-55° C.), (manufactured by Ciba Specialty Chemicals, trade name: IRGANOX 1076DWJ, volume-average particle diameter: 0.45 μm) was further added to the concentrated latex obtained, and the resulting mixture was stirred for 2 hours. Thus, latex L1 of the styrene/isoprene/styrene block copolymer was obtained.

It was confirmed that the first antioxidant 1A is present in the rubber constituting the rubber latex and the second antioxidant 2A was present in the dispersion medium.

A glass mold having a rubbing-processed surface (diameter: about 5 mm, rubbed part length: about 15 mm) was cleaned and preheated in an oven at 70° C. The glass mold was taken out of the oven, dipped in a coagulant comprising 83.95% of water, 16.00% of calcium nitrate and 0.05% of a surfactant for 5 seconds, and taken out of the coagulant. The mold covered with the coagulant was dried in an oven at 70° C. Thus, the glass mold covered with the coagulant was obtained.

The glass mold covered with the coagulant was dipped in the latex L1 of the styrene/isoprene/styrene block copolymer obtained in Example 1 for 10 seconds. The glass mold covered with the styrene/isoprene/styrene block copolymer film was taken out of the latex, and dipped in water at 60° C. for 20 minutes. The glass mold was taken out of water and air-dried at room temperature for 60 minutes. The mold was placed in an oven. The temperature in the oven was increased from 40° C. to 120° C. over 40 minutes, and the mold was pre-dried. The glass mold was then placed in an oven at 120° C. for 20 minutes to anneal the mold. The glass mold covered with the film was taken out of the oven, and cooled at room temperature. The styrene/isoprene/styrene block copolymer film was removed from the glass mold using talc.

Tensile strength of the film obtained was measured.

The film was irradiated with gamma rays, and tensile strength of the film was measured.

The film after the irradiation with gamma rays was heat-treated in a gear oven, and the tensile strength of the film was measured.

Measurement results of these tensile strengths are shown in Table 1.

### Example 2

A latex L2 of a styrene/isoprene/styrene block copolymer was obtained in the same manner as in Example 1, except for using an antioxidant 1B: octadecyl-3-(3,5-di-t-butyl-4-hydroxy-phenyl)propionate (manufactured by Ciba Specialty Chemicals, trade name: IRGANOX 1076) as a first antioxidant in place of the antioxidant 1A: 2,6-di-t-butyl-4-(4,6-bis(octylthio)-1,3,5-triazin-2-ylamino)phenol.

It was confirmed that the first antioxidant 1B was present in the rubber constituting the rubber latex and the second antioxidant 2A is present in the dispersion medium.

A film was obtained in the same manner as in Example 1 using the latex L2, and the film strength of the film was measured in the same manner as in Example 1. The results obtained are shown in Table 1.

### Example 3

100 parts of polyisoprene: IR (manufactured by Zeon Corporation, trade name: NIPOL IR2200L), 900 parts of cyclohexane and 0.5 part of a first antioxidant 1A: 2,6-di-t-butyl-4-(4,6-bis(octylthio)-1,3,5-triazin-2-ylamino)phenol (manufactured by Ciba Specialty Chemicals, trade name: IRGANOX 565) were added to a separable flask, and these were dissolved at room temperature under stirring.

A solution obtained by dissolving 15 parts of sodium dodecylbenzenesulfonate in 985 parts of water was added to the cyclohexane solution obtained, and the stirring was continued. The resulting solution was circulated 10 times using an emulsion disperser (manufactured by Pacific Machinery & Engineering Co., Ltd., trade name: MILDER 303V). Thus, an emulsified liquid was obtained. Cyclohexane and water were distilled away from the emulsified liquid obtained at 80° C. under reduced pressure of from −0.01 to −0.09 MPa to concentrate the liquid to a solid content concentration of 45%. The volume-average particle diameter of IR in the emulsified liquid was 1.3 μm.

2.86 parts of an aqueous dispersion (antioxidant concentration: 35%) comprising 1.0 part of a second antioxidant 2B: a butylation reaction product (melting point: 110° C.) of p-cresol and dicyclopentadiene, (manufactured by Nogawa Chemical Co., Ltd., trade name: NC904BN, volume-average particle diameter: 0.31 μm) was further added to the concentrated latex obtained. Thus, a latex of polyisoprene was obtained.

It was confirmed that the first antioxidant 1A was present in the rubber constituting the rubber latex and the second antioxidant 2B is present in the dispersion medium.

The latex was diluted with water, and the pH of the diluted latex was adjusted to 10.5 using potassium hydroxide. The solid content in the latex was adjusted to about 50%.

Each of dispersions of 1.5 parts of zinc oxide, 1.5 parts of sulfur, 0.5 part of ZEDC (zinc diethyldithiocarbamate) and 0.5 parts of ZDBC (zinc dibutyldithiocarbamate), each in terms of a solid content, per 100 parts of the latex solid content was added to the latex under continuous stirring.

The composition obtained was maintained at 35° C., and pre-vulcanized under stirring by shaking. Thus, a rubber latex compound L3 was obtained.

A film was obtained in the same manner as in Example using the latex compound L3. Strength of the film obtained was measured in the same manner as in Example 1. The results obtained are shown in Table 1.

### Comparative Example 1

A latex LC1 of a styrene/isoprene/styrene block copolymer was obtained in the same manner as in Example 1, except that the first antioxidant 1A: 2,6-di-t-butyl-4-(4,6-bis(octylthio)-1,3,5-triazin-2-ylamino)phenol was not added.

It was confirmed that the second antioxidant 2A was present in the dispersion medium constituting the rubber latex.

A film was obtained in the same manner as in Example 1 using the latex LC1. Strength of the film obtained was measured in the same manner as in Example 1. The results obtained are shown in Table 1.

### Comparative Example 2

A latex LC2 of a styrene/isoprene/styrene block copolymer was obtained in the same manner as in Example 1, except that the second antioxidant 2A: an aqueous dispersion of octadecyl-3-(3,5-di-t-butyl-4-hydroxyphenyl)propionate was not added.

It was confirmed that the second antioxidant 1A was present in the dispersion medium constituting the rubber latex.

A film was obtained in the same manner as in Example 1 using the latex LC2. Strength of the film obtained was measured in the same manner as in Example 1. The results obtained are shown in Table 1.

### Comparative Example 3

A latex LC3 of a styrene/isoprene/styrene block copolymer was obtained in the same manner as in Example 1, except that an aqueous dispersion (volume-average particle diameter: 0.98 μm) obtained by emulsifying, with sodium dodecylbenzene sulfonate, an antioxidant 2C: liquid styrenated phenol ((α-methylbenzyl)phenol, a mixture of 1-3 substituents) was used in place of an aqueous dispersion of the second antioxidant 2A: octadecyl-3-(3,5-di-t-butyl-4-hydroxyphenyl)propionate.

The first antioxidant 1A and the styrenated phenol 2C were present in the rubber constituting the rubber latex. As a result of analysis of a lower layer (precipitate) after centrifugal separation, it was confirmed that the styrenated phenol 2C was not substantially present in the dispersion medium.

A film was obtained in the same manner as in Example 1 using the latex LC3. Strength of the film obtained was measured in the same manner as in Example 1. The results obtained are shown in Table 1.

TABLE 1

| | Example | | | Comparative Example | | |
|---|---|---|---|---|---|---|
| | 1 | 2 | 3 | 1 | 2 | 3 |
| Rubber | | | | | | |
| SIS | 100 | 100 | — | 100 | 100 | 100 |
| IR | — | — | 100 | — | — | — |
| First antioxidant | | | | | | |
| 1A | 0.5 | — | 0.5 | — | 0.5 | 0.5 |
| 1B | — | 0.5 | — | — | — | — |
| Second antioxidant | | | | | | |
| 2A | 1.0 | 1.0 | — | 1.0 | — | — |
| 2B | — | — | 1.0 | — | — | — |
| 2C | — | — | — | — | — | (1.0) |
| Volume-average particle diameter (μm) | 0.45 | 0.45 | 0.31 | 0.45 | — | 0.98 |
| Film tensile strength (MPa) | | | | | | |
| Untreated | 24 | 24 | 20 | 24 | 24 | 24 |
| After gamma ray-irradiation | 22 | 22 | 20 | 17 | 22 | 22 |
| After heat treatment | 20 | 19 | 20 | 12 | 12 | 14 |

Notes in Table 1
SIS: Styrene/isoprene/styrene block copolymer
IR: Polyisoprene
1A: 2,6-di-t-butyl-4-(4,6-bis(octylthio)-1,3,5-triazin-2-ylamino)phenol
1B: Octadecyl-3-(3,5-di-t-butyl-4-hydroxyphenyl)-propionate
2A: Aqueous dispersion of octadecyl-3-(3,5-di-t-butyl-4-hydroxyphenyl)propionate
2B: Aqueous dispersion of butylation reaction product of p-cresol and dicyclopentadiene
2C: Styrenated phenol

The following facts are understood from Table 1.

Tensile strength of films is remarkably decreased by gamma ray-irradiation, particularly the heat treatment after gamma ray-irradiation, in all of the dip-molded film obtained from a rubber latex which does not contain the first antioxidant defined in the present invention as an antioxidant (Comparative Example 1), the dip-molded film obtained from a rubber latex which does not contain the second antioxidant defined in the present invention as an antioxidant (Comparative Example 2), and the dip-molded film obtained from a rubber latex containing two kinds of antioxidants but using an antioxidant having a melting point which falls outside the definition of the present invention in place of the second antioxidant (Comparative Example 3).

Contrary to this, the dip-molded film obtained from the rubber latex of the present invention maintains its tensile strength even after gamma ray-irradiation and a heat treatment for a long period of time.

1. A rubber latex comprising a rubber and an antioxidant, wherein an antioxidant in a first existing form is present in a rubber constituting the rubber latex, and an antioxidant in a second existing form has a melting point of 40° C. or higher and is present in a dispersion medium constituting the rubber latex.

2. The rubber latex according to claim 1, wherein the antioxidant in the second existing form present in a dispersion medium has a volume-average particle diameter of from 0.01 μm to 10 μm.

3. The rubber latex according to claim 1 or 2, wherein the rubber is a polymer containing a conjugated diene monomer unit as a constituting unit.

4. The rubber latex according to claim 3, wherein the polymer containing a conjugated diene monomer unit as a constituting unit is a block copolymer of an aromatic vinyl monomer and a conjugated diene monomer.

5. The rubber latex according to claim 4, wherein the block copolymer of an aromatic vinyl monomer and a conjugated diene monomer is a styrene/isoprene/styrene block copolymer.

6. The rubber latex according to claim 3, wherein the polymer containing a conjugated diene monomer unit as a constituting unit is a polyisoprene.

7. The rubber latex according to claim 1, wherein the antioxidant in the first existing form is present in an amount of from 0.1 to 3 parts by weight per 100 parts by weight of the rubber.

8. The rubber latex according to claim 1, wherein the antioxidant in the second existing faun is present in an amount of from 0.1 to 3 parts by weight per 100 parts by weight of the rubber.

9. A method for producing the rubber latex according to claim 1, comprising mixing an organic solvent solution, of a rubber constituting the rubber latex and an antioxidant for constituting an antioxidant in the first existing form, with a surfactant aqueous solution, thereby forming an emulsified product, removing an organic solvent from the emulsified product, and adding an aqueous dispersion of an antioxidant constituting the antioxidant in the second existing form to the emulsified product.

10. A rubber latex for dip molding comprising the rubber latex according to claim 1.

11. A dip-molded article obtained by dip-molding the rubber latex for dip molding according to claim 10.

12. A dip-molded article obtained by irradiating the dip-molded article according to claim 11 with radiation.

13. The dip-molded article according to claim 12, which is for medical use.
